(19) United States
(12) Patent Application Publication
(10) Pub. No.: US 2006/0235940 A1
(43) Pub. Date: Oct. 19, 2006

(54) Method and system for sharing personal attributes, sharing/ insertion/ terminal modules, internet access provider, proxy server, services provider and computer program for this method

(76) Inventors: Anne Boutroux, Hermanville Sur Mer (FR); Cedric Goutard, Douvres La Delivrande (FR); Rym Sahnoun, L'Yay Les Roses (FR)

Correspondence Address: YOUNG & THOMPSON, 745 SOUTH 23RD STREET, 2ND FLOOR, ARLINGTON, VA, 22202, US

(21) Appl. No.: 11/384,395

(22) Filed: Mar. 21, 2006

(30) Foreign Application Priority Data
Mar. 22, 2005 (FR) 05 02807

(51) Int. Cl. G06F 15/16

(52) U.S. Cl. 709/217

(57) ABSTRACT

In this method of sharing personal attributes of a user between several on-line services providers, a Proxy server of an Internet access provider spliced into the flow between the terminal and the world wide web, intercepts an attributes request addressed to a user terminal and redirects it automatically to a personal attributes provider selection module. The Internet access provider is the one that dynamically assigned an Internet address to the terminal so that it can browse the world wide web.

The present invention relates to a method and a system for sharing personal attributes, an Internet access provider, a Proxy server and a services provider for this method.

Here, the term “service” designates a set of tasks or of functions carried out by a multimedia server. These functionalities are, for example, the triggering of the delivery of information on the multimedia terminal of the user or of the delivery of a product to the premises of the user of the multimedia terminal.

Here, the expression “personal attributes of the user” designates any type of information pertaining to the user, such as, for example, personal data, an electronic purse, geolocation data, or else an electronic diary containing the user's time usage.

Such methods for sharing personal attributes have, for example, been proposed by the enterprise consortium called “Liberty Alliance” whose aim is the development of transactions over the Internet. These recommendations may, for example, be obtained from the Internet site http://www.projectliberty.org.

The methods of sharing attributes run counter to the methods employed today in which the attributes required for the personalization of a service are stored on the terminals of the users in “cookies”. Specifically, in the latter case, each cookies is specific to a services provider, so that there are as many cookies recorded on the terminal as services providers already contacted.

With the use of such cookies, it is not possible to share the personal attributes of one and the same user between several services providers.

In one of the methods proposed by the “Liberty Alliance” enterprise consortium:
c) a selection module automatically chooses an electronic provider of attributes from among several possible attributes providers as a function of an identifier of the user, each attributes provider being adapted to provide personal attributes of preregistered users,
d) in response to a request asking for personal attributes, sent by any one of the services providers, the attributes provider chosen by the selection module is interrogated to obtain the personal attributes required by the services provider,
e) the attributes obtained, during step d), are transmitted to the services provider, and
f) the services provider personalizes the service rendered to the user as a function of the attributes transmitted.

This method presupposes that each services provider knows, for a given user, the address of the selection module so as to be able to address thereto the attributes request. This is a drawback.

The invention aims to remedy this drawback by proposing a method of sharing personal attributes in which the services provider needs not know the address of the selection module.

The subject of the invention is therefore a method of sharing personal attributes of a user between several services providers, in which before steps c) to f):
a) the services provider contacted by the user dispatches the request asking for personal attributes to the terminal of the user by way of the world wide web and then,
b) a Proxy server of an Internet access provider spliced into the flow between the terminal and the world wide web, intercepts the attributes request addressed to the terminal and redirects it automatically to the selection module, the Internet access provider being the one that dynamically assigned an Internet address to the terminal so that it can browse the world wide web.

In the above method, it is not necessary for each services provider to know the address of the selection module or any other address specific to the implementation of a method of sharing personal attributes. Specifically, here, any attributes request sent by any services provider whatsoever to any user terminal whatsoever is intercepted and redirected automatically to the selection module by the Proxy server of the Internet access provider spliced into the flow. This simplifies the realization of services providers able to be implemented in a method of sharing personal attributes.

Moreover, it is not necessary to make provision in each services provider for a specific interface for communicating with and managing directly the selection module.

The modes of realization of this method may comprise one or more of the following characteristics:
during step b):
   the Proxy server redirects firstly the attributes request to a sharing module common to the whole set of services providers, then
   the sharing module interrogates the selection module in place of the services provider having sent the request asking for personal attributes;
before step a):
   an insertion module automatically modifies a request for connection of the terminal to the services provider so as to insert therein an item indicating that a method of sharing attributes is able to be implemented, the modified connection request thereafter being transmitted to the services provider, and
   in response to this modified connection request, the services provider automatically proceeds to step a);
   the interrogated attributes providers are implemented solely in respective servers for providing attributes independent of the user terminals and linked to the selection module by a local network internal to the Internet access provider or by the world wide web, during step d), the attributes provider chosen is interrogated by a sharing module implemented in a server of the Internet access provider, and during step e), this sharing module transmits the attributes obtained to the services provider by way of the world wide web;
   the attributes provider chosen is implemented in a user terminal, and during step d), a sharing module interrogates this attributes provider by inserting an interrogation request into an information stream set up between this terminal and the services provider using, for this purpose, the Proxy server, and during step e), a terminal module intercepts the response of the attributes provider in the information stream set up between the terminal and the services provider using the Proxy server and transmits the intercepted response to the services provider.

These modes of realization of the method of sharing attributes furthermore exhibit the following advantages:
the sharing module is common to the whole set of services providers and forms the specific interface with the selection module so that it is not necessary to implement a specific interface such as this in each services provider;
the use of an insertion module makes it possible to automatically trigger the implementation of the method of sharing attributes;
the use of a sharing module implemented on a server of the Internet access provider makes it possible to prevent the personal attributes from traveling between the user terminal and the Internet access provider, thereby boosting the security of the method; and
the insertion of interrogation requests intended for the user terminal in an information stream set up between this terminal and the services provider makes it possible to simply interrogate a terminal whose address is assigned dynamically by the Internet access provider during each connection of this terminal.

The subject of the invention is also a system for the sharing of personal attributes between several services providers, this system comprising:
a selection module able to choose and electronic provider of attributes from among several possible providers of attributes as a function of an identifier of the user,
several providers of attributes each able to provide personal attributes of preregistered users in response to a request asking for personal attributes sent by any one of the services providers,
providers of services able to personalize the service rendered to the user as a function of the personal attributes transmitted, and
an Internet access provider able to dynamically assign an Internet address to the user terminal so that it can browse the world wide web, this Internet access provider comprising a Proxy server spliced into the flow between the user terminal and the world wide web, in which:
the services providers are able to dispatch the request asking for personal attributes to the terminal of the user by way of the world wide web, and
the Proxy server is able to intercept the attributes request addressed to the terminal and to automatically redirect it to the selection module.

The subject of the invention is also an Internet access provider able to be implemented in the above method of providing attributes, this Internet access provider being able to dynamically assign an Internet address to the user terminal so that it can browse the world wide web, this Internet access provider comprising a Proxy server spliced into the flow between the user terminal and the world wide web, the Proxy server is able to intercept the attributes request addressed to the terminal and to redirect it automatically to the selection module.

The subject of the invention is also a sharing module able to be implemented in the method of sharing attributes this sharing module being able:
to interrogate the selection module in place of the services provider having sent the request asking for personal attributes,
to interrogate the attributes provider chosen by the selection module to obtain the personal attributes requested, and
to transmit the attributes obtained to the services provider by way of the world wide web.

The subject of the invention is also an insertion module able to automatically modify a request of connection of the terminal to the services provider so as to insert therein an item indicating that a method of sharing attributes is able to be implemented, the modified connection request thereafter being transmitted to the services provider.

The subject of the invention is also a terminal module able to be implemented in the method of sharing attributes. This terminal module is able to intercept the response of the attributes provider in the information stream set up between the terminal and the services provider using the Proxy server and to transmit the intercepted response to the services provider.

The subject of the invention is also a Proxy server and a services provider able to be implemented in the method of sharing attributes hereinabove.

Finally, the subject of the invention is a computer program able to be implemented in a sharing module, which comprises instructions for the implementation of steps d) and e) of a method of sharing personal attributes in accordance with any one of claims 4 or 5 herein appended, when these instructions are executed by the sharing module.

The invention will be better understood on reading the description which follows, given solely by way of example and offered with reference to the drawings in which:

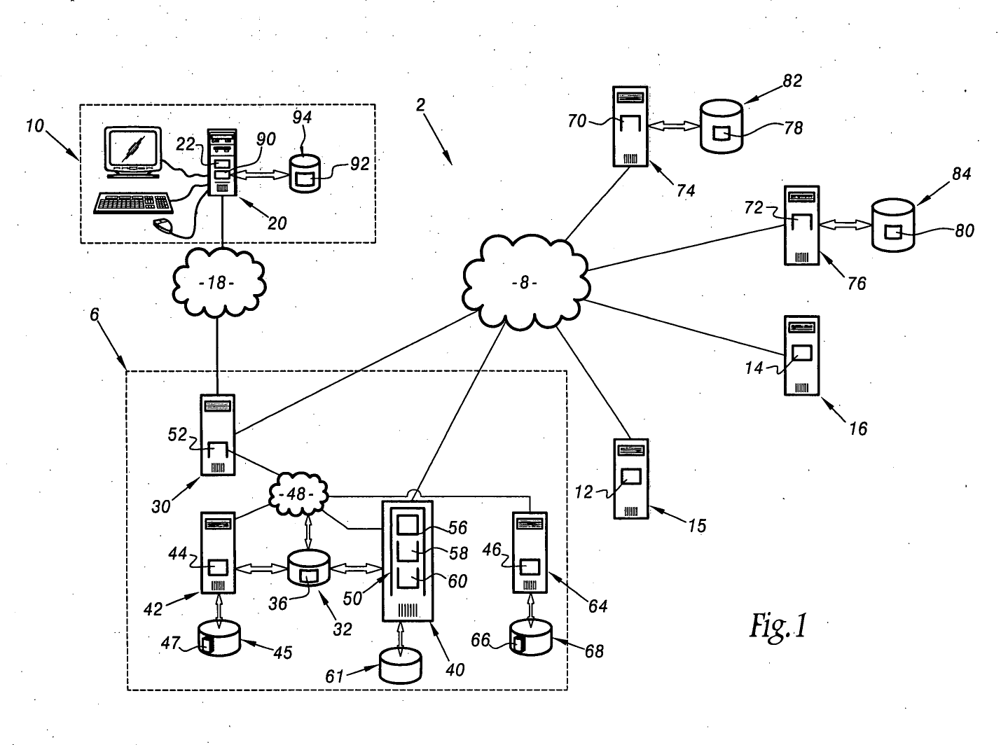

FIG. 1 is a schematic illustration of the architecture of a system for sharing personal attributes of users between several services providers,

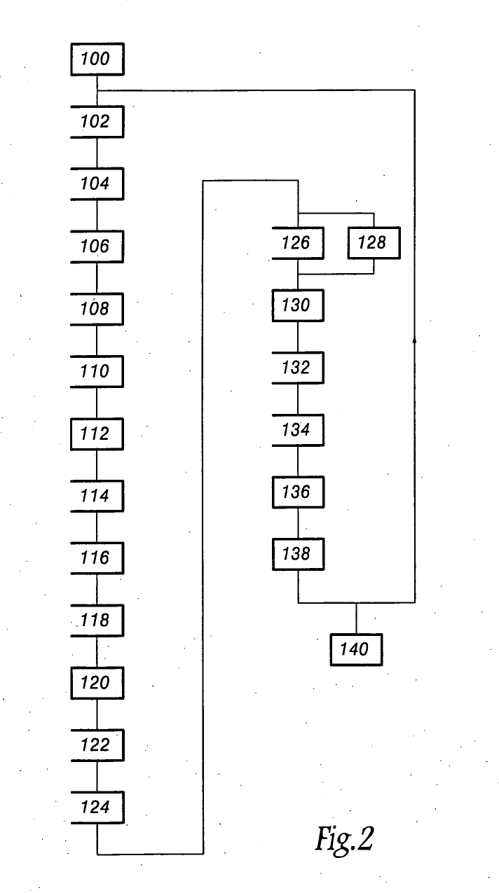

FIG. 2 is a flowchart of a method of sharing personal attributes implemented in the system of FIG. 1,

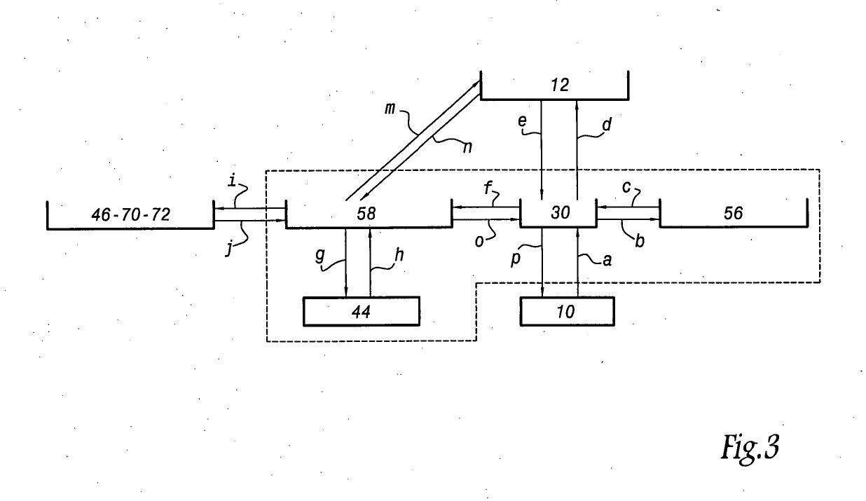

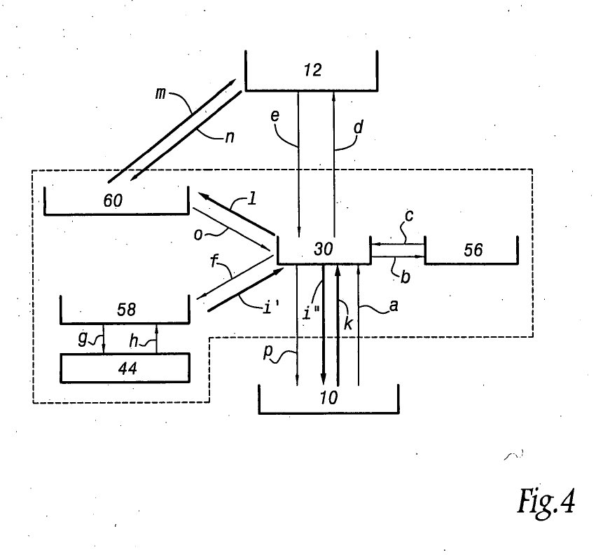

FIGS. 3 and 4 are schematic illustrations of the flow of information streams between various items of equipment of the system of FIG. 1 in two particular operating cases.

FIG. 1 represents a system, designated by the general reference 2, for sharing personal attributes of users between several on-line electronic services providers.

The system 2 comprises numerous user terminals each capable of being connected up by way of an Internet access provider 6 to services providers by way of the world wide web 8.

The world wide web 8 is, here, simply called the Internet network. This network is a packet switching network.

To simplify FIG. 1, only one user terminal 10 and two services providers 12 and 14 are represented.

The terminal 10 is linked to the Internet access provider 6 by way of an information transmission network 18. This network 18 is, for example, a circuit switching telephone network, a mobile telephone network or a local network of Intranet type.

The terminal 10 is able to browse the network 8. For this purpose, it is, for example, formed of a conventional computer 20 equipped with a screen and with a keyboard as well as with an Internet browser 22.

The services providers 12 and 14 are intended for performing tasks in response to requests from the user of the terminal 10. These providers 12 and 14 are here software modules executed on respective Internet servers 15 and 16 linked to the network 8.

Both these providers 12 and 14 are able to personalize the task rendered to the user of the terminal 10 as a function of personal attributes of the user of this terminal. For example, the provider 12 or 14 is a software module suitable for displaying on the terminal 10 an HTML (Hypertext Mark-up Language) home page personalized as a function of the personal attributes of the user. This personalization consists, for example, in indicating the name and the forename of the user and in applying this user's own page layout.

The functionalities of these providers allowing them to obtain the personal attributes of a user will be described in greater detail with regard to FIG. 2.

The Internet access provider 6 is able to dynamically assign a network address to the station 10 so that the latter can browse the network 8. This network address is typically an IP (Internet Protocol) address.

In order to allow access to the network 8, it comprises in particular an HTTP (Hyper Text Transfer Protocol) Proxy server 30 and information storage means such as a memory 32.

The Proxy server 30 is spliced into the flow between the station 10 and the network 8. The expression “spliced into the flow” designates here the fact that the whole set of HTTP information streams exchanged between the terminal 10 and the network 8 passes by way of the Proxy server 30. Thus, all of the HTTP requests and responses sent by the terminal 10 or destined for the terminal 10 pass via the Proxy server 30.

The memory 32 contains in particular a database 36 associating with each IP address dynamically assigned to a user terminal, an identifier of this user.

In the mode of realization of FIG. 1, the Internet access provider also comprises an iCAP (Internet Content Adaptation Protocol) server 40, a computer server 42 on which is executed a selection module 44 and an electronic provider of attributes 46.

These various elements of the Internet access provider 6 are linked to one another by way of a local information transmission network 48.

The selection module 44 is linked to a memory 45 containing a database 47. This database 47 associates with each user identifier the address of one or more providers of attributes able to provide the value of at least one attribute for this user. This selection module is known by the expression “discovery service” in the “Liberty Alliance” recommendations.

The server 40 implements a service 50 of sharing personal attributes. The service 50 is, for example, a computer program. This service 50 is able to process HTTP requests or responses intercepted by the Proxy server 30. For this purpose, the Proxy server 30 comprises an iCAP client 52 equipped with an iCAP interface comprising a connector making it possible to link it up to the server 40 by way of the network 48. This iCAP client is able to communicate with the server 40 using the iCAP protocol. The iCAP protocol is a protocol standardized by the IETF (Internet Engineering Task Force) body for the systematic transformation of contents over the Internet. More precisely, the iCAP client 52 allows the Proxy server 30 following the interception of HTTP requests or responses, to perform processing operations on these HTTP requests or responses present in the HTTP stream of information exchanged between the terminal 10 and the network 8 as a function of predetermined rules. Here, these rules are configured in such a way that only the HTTP requests and responses necessary for the implementation of the method of FIG. 2 are intercepted and transmitted to the service 50.

The service 50 is able to process the HTTP requests or responses intercepted so as to process them in place of the terminal 10 or else to modify them before reinserting them into the HTTP stream of information exchanged between the terminal 10 and the network 8. The functionalities of the service 50 will be described in greater detail with regard to FIG. 2. Here, it is simply indicated that this service 50 essentially comprises:
a module 56 for inserting items into requests for connection to services providers, these items indicating that a method of sharing attributes may be implemented,
a sharing module 58 suitable for providing a services provider with the personal attributes requested, when these attributes are able to be obtained from the provider 46 or in another electronic provider linked to the network 8, and
a terminal module 60 suitable for providing a services provider with the personal attributes requested, when the latter are obtained from a user terminal.

The server 40 is able to communicate directly with any one of the services providers, by way of the network 8 using the HTTP protocol.

Preferably the server 40 is a conventional programmable electronic computer able to execute instructions recorded on an information recording medium 61. Here, the medium 61 comprises instructions for the execution of the steps of the method of FIG. 2, that are carried out by the service 50.

The provider 46 is a software module implemented on a computer server 64 on which it executes.

The provider 46 is able to respond to a request asking for attributes by choosing from a database 66, the value of the attributes requested, as a function of a user identifier. The database 66 is recorded in a memory 68 linked to the provider 46.

The system 2 also comprises two other attributes providers 70 and 72. These providers 70 and 72 are also software modules implemented on computer servers 74, 76 linked to the service 50, by way of the network 8. The providers 70, 72 are, for example, identical to the provider 46. The providers 70, 72 are linked to respective databases 78 and 80, contained in respective memories 82 and 84. The databases 78 and 80 are, for example, structurally identical to the database 66 and differ from this database 66 only in their content.

Finally, here, a provider 90 of attributes is also implemented, in the terminal 10. A database 92 containing attributes of a user of the terminal 10 is recorded in a memory 94 of the terminal 10.

The manner of operation of the system 2 will now be described in conjunction with the method of FIG. 2 and the information streams illustrated in FIGS. 3 and 4.

In FIGS. 3 and 4, the information streams between the various elements of the system 2 are represented by oriented arrows. The origin of each arrow starts from the element which sends the information, while the tip of the arrow points to the element which receives the information. In FIGS. 3 and 4, the elements of the system 2 that have already been described in conjunction with FIG. 1 bear the same numerical references.

The arrows in FIGS. 3 and 4 are referenced with the aid of the letters a to p. In the subsequent description, for each step of the flowchart of FIG. 2, the corresponding arrow in FIG. 3 and/or 4 is indicated between brackets.

Initially, the terminal 10 connects up, during a step 100, to the network 8 by way of the Internet access provider 6. During this step 100, the Internet access provider 6 dynamically assigns an IP address to the terminal 10 so that the latter can browse the network 8.

Thereafter, the terminal 10 dispatches, during a step 102, an HTTP request for connection to any HTML page whatsoever of a services provider (arrow a). In the subsequent description, it is assumed that the services provider contacted is the provider 12.

This HTTP connection request, after having crossed the network 18, is intercepted, during a step 104, by the Proxy server 30. More precisely, during this step 104, the connection request is intercepted by the iCAP client 52 which redirects it automatically to the service 50 by way of the network 48 (arrow b).

The module 56 then inserts, during a step 106, a header into the HTTP connection request, containing an item indicating the medium of an attributes sharing service. Preferably, this item also comprises the list of attributes available for a user.

During a step 108, the HTTP connection request thus modified is dispatched to the iCAP client 52 (arrow c) then transmitted to the provider 12 (arrow d).

In response to this modified HTTP connection request, the provider 12 sends, during a step 110, an attributes request (arrow e) addressed to the terminal 10. Preferably, this attributes request contains an identifier of the provider 12.

During a step 112, this attributes request is intercepted by the iCAP client 52 and redirected automatically to the sharing module 58 (arrow f).

The module 58 identifies, during a step 114, the user on the basis of the recipient's IP address contained in the HTTP request intercepted during step 112 and by virtue of the database 36.

Thereafter, the module 58 interrogates, during a step 116, the selection module 44 so as to ascertain the address of the attributes provider to be contacted to obtain the personal attributes requested by the server 12 (arrow g) . During this interrogation, the module 58 provides the module 44 with an identifier of the user as well as with the list of personal attributes requested and, possibly, with an identifier of the provider that sent this request.

During a step 118, the module 44 chooses, from among the whole set of available attributes providers, the one which is able to provide the attributes requested by the server 12. For this purpose, the module 44 selects from the database 47 the appropriate attributes provider as a function of the identifier of the user and of the list of attributes requested. The identifier of the provider is, for example, used to limit the number of providers of attributes able to be used to respond to the request of the provider 12 or to know whether this service provider is authorized to request personal attributes from these attributes providers.

Once the attributes provider has been selected, during a step 120, the module 44 forwards the address of this attributes provider to the module 58 (arrow h).

The module 58 then addresses an HTTP request for provision of attributes to the attributes provider chosen by the selection module 44, during a step 122 (FIG. 3: arrow i). The HTTP attributes provision request furthermore contains an identifier of the user and a list of the personal attributes requested by the provider 12. If the attributes provider chosen is the provider 46, the module 58 dispatches the HTTP attributes provision request by way of the local network 48.

In the case where the attributes provider chosen is the provider 70 or 72, then the module 58 sets up a new HTTP connection with the provider 70 or 72 to dispatch this request for provision of attributes by way of the network 8.

Finally, if the attributes provider chosen is the provider 90, then the HTTP attributes provision request is transmitted to the iCAP client 52 (FIG. 4: arrow i′) which inserts it into the HTTP information stream transmitted between the provider 12 and the terminal 10 (FIG. 4: arrow i″). Thus, in FIG. 4, the stream i passes by way of the Proxy server 30 and it is not compulsory to set up a new HTTP connection with the terminal 10.

In response to the attributes provision request received, if the attributes provider chosen is one of the providers 46, 70 and 72, the attributes provider dispatches, during a step 124, the attributes requested to the module 58 (FIG. 3: arrow j) in an HTTP response.

If the attributes provider chosen is the provider 90, the provider 90 dispatches the attributes requested to the module 60, inserting them into an HTTP response intended for the provider 12 (FIG. 4: arrow k). This response is then intercepted by the Proxy server 30 and redirected automatically to the module 60 (FIG. 4: arrow l).

The module 58 or 60 having received the attributes requested, dispatches them, during a step 126, to the provider 12 using for this purpose an HTTP connection directly set up between the server 40 and the provider 12 (arrow m).

In parallel, during a step 128, the information streams i and m or l and m are recorded by the module 58 and associated with the identifier of the services provider that requested these personal attributes.

During a step 130, the provider 12 personalizes the tasks that it has to perform as a function of the personal attributes dispatched during step 126. For example, it personalizes the home page of the Internet site.

The personalized home page is then transmitted, during a step 132, to the module 58 or 60 in response to the HTTP request transmitted during step 126 (arrow n). The response is transmitted to the module 58 or 60 which carried out step 126.

The response received by the service 50 is then transmitted, during a step 134, to the iCAP client 52, by way of the local network 48 (arrow o).

The iCAP client 52 then inserts this response into the HTTP stream between the provider 12 and the terminal 10, during a step 136 (arrow p). The response is therefore transmitted to the terminal 10.

Thereafter, during a step 138, the remainder of the exchanges of information between the terminal 10 and the provider 12 is undertaken normally without any HTTP request or response being intercepted and transmitted to the service 50.

When the terminal 10 contacts another services provider, such as, for example, the provider 14 or another HTML page of the same services provider that is requesting attributes, steps 102 to 138 are iteratively repeated.

At regular intervals, the Internet access provider 6 bills, during a step 140, the implementation of the method of sharing attributes to the services providers by establishing the price as a function, for example, of the streams j, m or l, m stored.

Numerous other modes of realization of the system 2 are possible. For example, the selection module 44 is, as a variant, implemented in a computer server linked to the Internet access provider 6, by way of the network 8. In this variant, preferably, the exchanges of information between the Internet access provider and the selection module are encrypted, either, for example, with a key specific to the services provider that requested the personal attributes, or with the aid of a key specific to the sharing module.

As a variant, no provider of attributes is implemented in the user terminals. This makes it possible to boost the security of the method, since the personal attributes are never transmitted over the network 18.

The Internet access provider 6 does not necessarily comprise an attributes provider.

It is also possible to implement the attributes provider in another user terminal apart from the one used by the user. In this variant, the sharing module contacts this other user terminal by dispatching to it, for example, an SMS (Short Message Service) message containing a URL (Uniform Resource Locator). The attributes provider then provides the attributes requested only if the URL transmitted is activated by a user of this other terminal. Such a variant is useful when a personal attribute corresponds to the time usage or to the calendar of a contact of the user connected to the services provider.

To simplify the hardware architecture of the system 2, the service 50 may be implemented in the Proxy server 30. Likewise, the selection module 44 and the provider 46 may be implemented in one and the same computer server. The selection module 44 and the service 50 for sharing attributes or the sharing module 58 may also be implemented in one and the same common computer server.

A services provider can dispatch a single request asking for personal attributes which gives rise to the interrogation of several attributes providers, if the attributes requested are not all available from the same attributes provider. In this case, the selection module 44 sends back, during step 120, several addresses of attributes providers to the sharing module 58. The sharing module 58 thereafter addresses, during step 122, a request for the provision of attributes to each of the attributes providers chosen. The attributes providers interrogated dispatch, during step 124, the attributes requested to the module 58 which groups them together into a single response dispatched to the services provider.

Here, step 130 has been described in the case of the personalization of the content of an HTML page with the personal attributes of the user. As a variant, the personalization of the service rendered is not visible on an HTML page but consists in modifying the information processing carried out by the services provider as a function of the personal attributes received.

As a variant, the sharing module interrogates the selection module even before the services provider has sent a request asking for attributes. For example, the sharing module interrogates the selection module upon connection of the user terminal to the network 8.

Finally, as a variant, the Proxy server contained in the Internet access provider is linked to the other elements of the Internet access provider by way of the network 8.

In a simplified mode of operation, the selection module chooses the attributes providers solely as a function of the identifier of the user received.

The description hereinabove has been set forth in the particular case where the network 8 is the world wide web. However, the network 8 may be any other type of long-range network based on wire, radio or other technologies. For example, the network 8 may be a WAP (Wireless Application Protocol) network.

1. A method of sharing personal attributes of a user between several electronic providers of on-line services, in which:
d) in response to a request asking for personal attributes, sent by any one of the services providers, an attributes provider is interrogated to obtain the personal attributes required by the services provider,
e) the attributes obtained, during step d), are transmitted to the services provider, and
f) the services provider personalizes the service rendered to the user as a function of the attributes transmitted,
wherein, before steps d) to f)
a) the services provider contacted by the user dispatches the request asking for personal attributes to the terminal of the user by way of a network and then,
b) a Proxy server of an Internet access provider spliced into the flow between the terminal and the network, intercepts the attributes request addressed to the terminal and redirects it automatically to an attributes provider, the Internet access provider being the one that dynamically assigned an Internet address to the terminal so that it can browse the network.

2. The method as claimed in claim 1, in which:
c) a selection module automatically chooses an electronic provider of attributes from among several possible attributes providers as a function of an identifier of the user, each attributes provider being adapted to provide personal attributes of preregistered users,
during step d) the interrogated attributes provider is the one selected during step c), and
during step b) the attributes request intercepted is firstly redirected automatically to the selection module before being transmitted to the attributes provider chosen by this selection module.

3. The method as claimed in claim 2, wherein during step b):
the Proxy server redirects firstly the attributes request to a sharing module common to the whole set of services providers, then
the sharing module interrogates the selection module in place of the services provider having sent the request asking for personal attributes.

4. The method as claimed in claim 1, wherein before step a),
an insertion module automatically modifies a request for connection of the terminal to the services provider so as to insert therein an item indicating that a method of sharing attributes is able to be implemented, the modified connection request thereafter being transmitted to the services provider, and
in response to this modified connection request, the services provider automatically proceeds to step a).

5. The method as claimed in claim 2, wherein the interrogated attributes providers are implemented solely in respective servers for providing attributes independent of the user terminals and linked to the selection module by a local network internal to the Internet access provider or by the world wide web, and
during step d), the attributes provider chosen is interrogated by a sharing module implemented in a server of the Internet access provider, and
during step e), this sharing module transmits the attributes obtained to the services provider by way of the world wide web.

6. The method as claimed in claim 1, wherein the attributes provider chosen is implemented in a user terminal, and
during step d), a sharing module interrogates this attributes provider by inserting an interrogation request into an information stream set up between this terminal and the services provider using, for this purpose, the Proxy server, and
during step e), a terminal module intercepts the response of the attributes provider in the information stream set up between the terminal and the services provider using the Proxy server and transmits the intercepted response to the services provider, the sharing module and the terminal module being implemented in the Internet access provider.

7. A system for the automatic sharing of personal attributes of a user between several on-line electronic services providers, this system comprising:
at least one provider of attributes able to provide personal attributes of preregistered users in response to a request asking for personal attributes sent by any one of the services providers,
providers of services able to personalize the service rendered to the user as a function of the personal attributes transmitted, and
an Internet access provider able to dynamically assign an Internet address to a user terminal so that it can browse a network, this Internet access provider comprising a Proxy server spliced into the flow between the user terminal and the network,
wherein:
the services providers are able to dispatch the request asking for personal attributes to the terminal of the user by way of the network, and
the Proxy server is able to intercept the attributes request addressed to the terminal and to automatically redirect it to one of the attributes providers.

8. The system as claimed in claim 7, in which:
the system comprises a selection module able to choose an electronic provider of attributes from among several possible providers of attributes as a function of an identifier of the user, and
the Proxy server is able to automatically redirect the attributes request intercepted to the selection module before the former is transmitted to the attributes provider chosen by the selection module.

9. The system as claimed in claim 8, wherein:
the Proxy server is able to firstly redirect the request asking for attributes to a sharing module common to the whole set of services providers,
the Internet access provider comprises the sharing module, this sharing module being able to interrogate the selection module in place of the services provider having sent the request asking for personal attributes.

10. An Internet access provider able to be implemented in a method of sharing personal attributes in accordance with claim 1, this Internet access provider being able to dynamically assign an Internet address to the user terminal so that it can browse the network, this Internet access provider comprising a Proxy server spliced into the flow between the user terminal and the network,
wherein the Proxy server is able to intercept the attributes request addressed to the terminal and to redirect it automatically to an attributes provider.

11. A sharing module able to be implemented in a method of sharing attributes in accordance with claim 5, wherein the sharing module is able:
to interrogate the selection module in place of the services provider having sent the request asking for personal attributes,
to interrogate the attributes provider chosen by the selection module to obtain the personal attributes requested, and
to transmit the attributes obtained to the services provider by way of the world wide web.

12. An insertion module able to be implemented in a method of sharing attributes in accordance with claim 4, wherein the insertion module is able to automatically modify a request of connection of the terminal to the services provider so as to insert therein an item indicating that a method of sharing attributes is able to be implemented, the modified connection request thereafter being transmitted to the services provider.

13. A terminal module able to be implemented in a method of sharing attributes in accordance with claim 6, wherein this terminal module is able to intercept the response of the attributes provider in the information stream set up between the terminal and the services provider using the Proxy server and to transmit the intercepted response to the services provider.

14. A Proxy server of an Internet access provider able to be implemented in a method of sharing personal attributes in accordance with claim 1, wherein the Proxy server is spliced into the flow between the user terminal and the world wide web, and is able to intercept the attributes request addressed to the terminal and to redirect it automatically to the attributes provider.

15. A services provider able to be implemented in a method of sharing personal attributes, in accordance with claim 1, wherein the services provider is able to dispatch the request asking for personal attributes to the terminal of the user by way of the world wide web.

16. A computer program able to be implemented in a sharing module, which comprises instructions for the implementation of steps d) and e) of a method of sharing personal attributes in accordance claim 5, when these instructions are executed by said sharing module.
